(19) United States
(12) Patent Application Publication
(10) Pub. No.: US 2026/0267408 A1
(43) Pub. Date: Sep. 10, 2026

(54) TRACKING SYSTEM FOR SIMULATING BODY MOTION

(71) Applicant: REFRACT TECHNOLOGIES PTE LTD, Singapore (SG)

(72) Inventors: Muhammad Bin Zainal Ikhwan, Singapore (SG); Yu Yang Chng, Singapore (SG); Aloysius Kay Boon Fong, Singapore (SG)

(73) Assignee: REFRACT TECHNOLOGIES PTE LTD, Singapore (SG)

(21) Appl. No.: 18/718,108

(22) PCT Filed: Nov. 25, 2022
(86) PCT No.: PCT/SG2022/050861

§ 371 Date: Jun. 10, 2024

(30) Foreign Application Priority Data
Dec. 17, 2021 (SG) 10202114057R

(51) Int. Cl. G06F 3/01; G06F 3/03; G06F 3/0338; G06T 7/246; G06T 7/62; G06T 7/73

(52) U.S. Cl. CPC G06F 3/014; G06F 3/0304; G06F 3/0338; G06T 7/248; G06T 7/62; G06T 7/74; G06T 2207/10016; G06T 2207/30196

(57) ABSTRACT

According to a first aspect of the present invention, there is provided a tracking system for simulating boy motion into a computing environment, the system comprising one or more processors; an optical sensor configured to signal that movement of the optical sensor has occurred through the one or more processors detecting that captured successive frames are different, the one or more processors 0 measuring the movement by referencing set points across the successive frames; a plurality of inertial measurement units, each controlled by the one or more processors to measure rotational data; and a hub in communication with the inertial measurement units and the optical sensor, wherein the hub receives the rotational data from the plurality of inertial measurement units over one more wireless communication channels, the hub controlled by the one or more processors to combine the rotational 5 data obtained while tracking the body motion with data of the measured movement obtained while tracking the body motion, to output a data stream that enables simulation of the body motion in the computing environment, wherein a body part movement in the computing environment id deduced from its measured rotational data and the measured rotational data of other connected body parts and the position of the body in the computing environment is deduced from the data of the measured movement.

### FIELD OF INVENTION

The present disclosure relates to a tracking system for simulating body motion into a computing environment.

### BACKGROUND

Virtual reality (VR) is associated with applications that comprise immersive, highly visual, computer-simulated environments. These environments typically simulate a physical presence of a user in places in a real or an imagined world.

In an VR system, a problem is to track user movement and map it into the computing environment. Full body tracking suits for both commercial and industrial uses based on “outside in” tracking use base station sensors. An entity in the VR system relies on these base station sensors to estimate its position and/or orientation. These are subjected to occlusion and require a lot of space.

Alternatively, in “inside out” tracking, a camera is placed on a tracked device and looks outward to determine its location in the environment. Known headsets that work without markers have multiple cameras facing different directions to get views of its surrounding. These headsets require for controllers to be seen by the headset cameras to track hand movement. As such, they are also subject to occlusion.

An object of the present invention is to provide a solution that addresses the above shortcomings.

### SUMMARY OF THE INVENTION

According to a first aspect of the present invention, there is provided a tracking system for simulating body motion into a computing environment, the system comprising one or more processors; an optical sensor configured to signal that movement of the optical sensor has occurred through the one or more processors detecting that captured successive frames are different, the one or more processors measuring the movement by referencing set points across the successive frames; a plurality of inertial measurement units, each controlled by the one or more processors to measure rotational data; and a hub in communication with the inertial measurement units and the optical sensor, wherein the hub receives the rotational data from the plurality of inertial measurement units over one or more wireless communication channels, the hub controlled by the one or more processors to combine the rotational data obtained while tracking the body motion with data of the measured movement obtained while tracking the body motion, to output a data stream that enables simulation of the body motion in the computing environment, wherein a body part movement in the computing environment is deduced from its measured rotational data and the measured rotational data of other connected body parts and the position of the body in the computing environment is deduced from the data of the measured movement.

A quaternion representation of the rotational data may be used to deduce the body part movement in the computing environment.

The deduction of the body part movement in the computing environment may be based on one or more forward kinematic algorithms.

The optical sensor may be integrated with the hub and movement of the optical sensor occurs from motion of the body on which the hub is worn.

Measurement of movement may commence from the optical sensor capturing its first frame, the first frame providing a starting point for tracking the body motion.

The hub may be configured to pair with the plurality of inertial measurement units through proximity detection of their emitted wireless signal.

The hub may be further configured to determine assignment of a body part on which each of the plurality of inertial measurement units is worn through analysis of its output rotational data and strength of its emitted wireless signal relative to the hub.

The hub may be further configured during pairing to save a unique identifier of each of the plurality of inertial measurement units against the assigned respective body part.

Following pairing, the one or more processors may be configured to perform calibration using data on dimensions of body parts on which the plurality of inertial measurement units is worn before tracking of the body motion commences.

The one or more processors may analyse images containing the body parts to derive their dimensions.

The dimensions may be derived using one or more of a machine learning algorithm and skeletal structure models.

The images may be taken by the optical sensor.

The derivation of the dimensions may be done in conjunction with the plurality of the inertial measurement units being worn on the respective body parts to cross reference strength of their emitted wireless signals against measurement data based on the corresponding body part images.

A base pose for adoption before body motion capture can commence may be predetermined in the computing environment.

The measured rotational data may be used to derive an offset from the base pose, the offset being usable to construct a current pose.

The tracking system of any one or more of the preceding claims, wherein the hub may be configured to allow extraction of the measured rotational data from one or more of the plurality of inertial measurement units and/or the data of the measured movement from the optical sensor, obtained while tracking the body motion, for recording as a macro.

A position of the body obtained from the data of the measured movement may be based on visual simultaneous localisation and mapping.

The optical sensor may be any one or more of a stereoscopic camera, LIDAR and optical sonar sensors.

At least one of the one or more processors may be hosted in a computer platform.

The deduction of the body part movement in the computing environment and the deduction of the position of the body in the computing environment may be performed in the computer platform to generate the data stream in the computer platform.

According to a second aspect of the present invention, there is provided a method of simulating body motion into a computing environment, the method comprising measuring movement of an optical sensor obtained while tracking the body motion by referencing set points across successive frames captured by the optical sensor that are different; combining, in a hub, measured rotational data obtained while tracking the body motion with data of the measured movement, the measured rotational data being received in the hub from a plurality of inertial measurement units over one or more wireless communication channels; and output a data stream that enables simulation of the body motion in the computing environment, wherein a body part movement in the computing environment is deduced from its measured rotational data and the measured rotational data of other connected body parts and the position of the body in the computing environment is deduced from the data of the measured movement.

### BRIEF DESCRIPTION OF THE DRAWINGS

Representative embodiments of the present invention are herein described, by way of example only, with reference to the accompanying drawings, wherein:

FIG. 1 shows deployment of a tracking system, in accordance with one embodiment of the present invention, onto a body.

FIG. 2 shows a flow chart for pairing of inertial measurement units with a hub of the tracking system of FIG. 1.

FIG. 3 shows an internal kinematic humanoid structure used to drive animation of an avatar representation of the body of FIG. 1 in a computing environment.

FIG. 4 shows a flow chart of data acquisition by the tracking system of FIG. 1 during body motion capture and transmission to a receiving computer platform.

FIG. 5 shows a flow chart for sending data from an application layer to the tracking system of FIG. 1.

FIG. 6 shows a kinematic model of an arm.

FIG. 7 shows a flow chart used by the tracking system of FIG. 1 for simulating body motion into a computing environment.

### DETAILED DESCRIPTION

In the following description, various embodiments are described with reference to the drawings, where like reference characters generally refer to the same parts throughout the different views.

The present application falls within the field of virtual reality, augmented reality or other form of visual, immersive computer simulated environment provided to a user. Virtual reality or VR refers to a computer simulated environment that can be interacted with by the user using hardware that can map or simulate the user's motion into the computer simulated environment. Augmented reality or AR refers to superimposition of virtual images on a real-world environment, or otherwise combining them through using a head mounted device (HMD) that allows the user to still see the real world.

To map user motion into the computer simulated environment, there are known approaches that use one or more sensors, such as lighthouses that are configured to monitor photosensors present in a HMD worn by a user, to determine the location of the user relative to the lighthouses. The HMD also has sensors, such as cameras, which require for a body part (such as a hand) to be in frame to determine the location of the hand relative to the HMD. These known approaches may suffer from occlusion occurring at the sensors that are used to determine the location of the user and the position of the user's limbs.

The hardware components of an optical sensor, inertial measurement units and a hub used in the present application to capture the user's motion and map it into the computer-simulated environment seek to address such occlusion issues by circumventing the need to calibrate against a pre-determined landmark when initialising an avatar representation of the user in the computing environment. To achieve this, the first frame that the optical sensor captures already provides the starting point to commence motion capture of the user in the real-world environment. That is, a starting position is automatically acquired when the optical sensor is initialised and detects that the background in the frame is variant. Pre-determined landmarks are thus not necessary.

A frame is one of many still images which compose the complete body motion capture. As the user moves in the real-world environment, the location of the user's avatar in the computing environment then depends on successive frames captured by the optical sensor. When it is detected that successive frames are different, it signals that movement of the user has occurred. The amount of movement is then measured by referencing or comparing set points across the successive frames. Set points are landmarks within each frame that are automatically determined and not pre-defined. Set points may therefore be different in each of the successive frames. A difference in the spatial distance between such set points in subsequent frames and in earlier frames is used to calculate a shift in the user's position during the tracked motion. In one approach, successive frames are considered different if they contain sufficient separate and distinct features, which results in different set points in each of these successive frames. That is, in addition to being used to measure a change in position of the user, set points are used as a measure of tolerance to determine whether successive frames are different. On the other hand, if the set points in successive frames remain the same, it is concluded that the user's position has not changed and such successive frames are not considered to be different. When determining whether successive frames are different, filters are employed to disregard occurrences like noise artifacts (such as a person walking past the frame).

Mapping of body part movement, such as movement and rotation of limbs is then obtained through processing rotational data that is measured by a plurality of inertial measurement units, each worn on a body part. For instance, each limb may have two inertial measurement units, one on an upper limb and the other on a lower limb. An inertial measurement unit may measure acceleration and/or angular velocity and/or magnetic field along the x, y, z coordinates.

The hub acts as a central module to consolidate the rotational data from each of the plurality of inertial measurement units. Performing data combination at the hub is also advantageous as it allows for use across different operating systems, such as those used in smart phones, game consoles, Linux and Mac.

The hub receives this data from the plurality of inertial measurement units over one or more wireless communication channels, i.e. each of the plurality of inertial measurement units may communicate wirelessly with the hub over a dedicated frequency bandwidth. Such communication over a wireless channel differs from headset cameras determining the location of hand controllers by being visible in their field of view, which does not use a communication channel. The present approach thus does not suffer from occlusions that occur when a line of sight between the headset cameras and the hand controllers is broken.

The hub also combines data of the movement that is measured from the successive frames captured by the optical sensor with the consolidated rotational data measured by the plurality of the inertial measurement units. This data combination facilitates the output of a data stream that enables simulation of the user motion in the computing environment. User motion refers to all poses a body executes while moving from one position to another, which includes rotation and translation of all body parts and a change of a co-ordinate location of the body. The combination of the rotational data, the acceleration data and the measured movement data may use a fusion algorithm that combines location or motion vectors from different coordinate systems to give an overall vector.

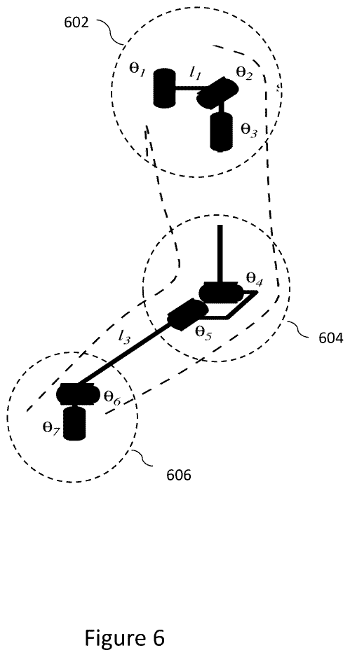

In one implementation, while the plurality of inertial measurement units can measure both linear acceleration and rotational acceleration data of the body parts on which they are worn, the hub simply uses measured rotational data, obtained during body motion capture, to deduce body part movement. The hub does so by evaluating the measured rotational data of that body part against the measured rotational data of other connected body parts. The use of rotational data to deduce body part motion is based on the principle that when one part of the body moves, joints of that part and joints of other connected body parts will rotate, due to strain and boundaries of joint rotation. For instance, with reference to FIG. 6, if an elbow joint 604 is moved, this would cause movement in the connecting shoulder joint 602 and movement in the connecting wrist joint 606. An inertial measurement unit located in proximity to each of these joints 602, 604, 606 will measure rotational data (Θ1, Θ2, Θ3), (Θ4, Θ5) and (Θ6, Θ7) respectively. The motion of the elbow joint 604 can then be simulated by the measured rotational data output by these inertial measurement units. The deduction of a body part movement in the computing environment may use forward kinematic algorithms where, for example, the position of a limb is obtained after its rotation is measured. There may be, for example, an algorithm for each body part that establishes a set of transformations from one joint frame to the next. By combining all these transformations from frame 0 to frame n and defining the dimensions of each link between adjacent joint frames, an entire transformation matrix may be obtained to characterise the relative movement allowed at each joint.

Simulation of the user motion is then completed by fixing the position of the body in the computing environment, that is determining the co-ordinates of the user's avatar in the computing environment. This is determined by the movement data measured from the successive frames captured by the optical sensor.

In one approach, a quaternion representation of the rotational data is used to deduce the body part movement in the computing environment. Quaternions are rotation data that is derived from complex numbers and are an alternate way to describe orientation or rotations in 3D space, where a quaternion matrix is represented by 4×1 data values. They uniquely describe any three-dimensional rotation about an arbitrary axis and do not suffer from gimbal lock associated with the Euler rotation matrix, which occurs when two axes are the same and causes the third axis to lock. Quaternions provide the information necessary to rotate a vector with just four numbers instead of the 3×3 or 4×4 matrices needed with Euler rotation.

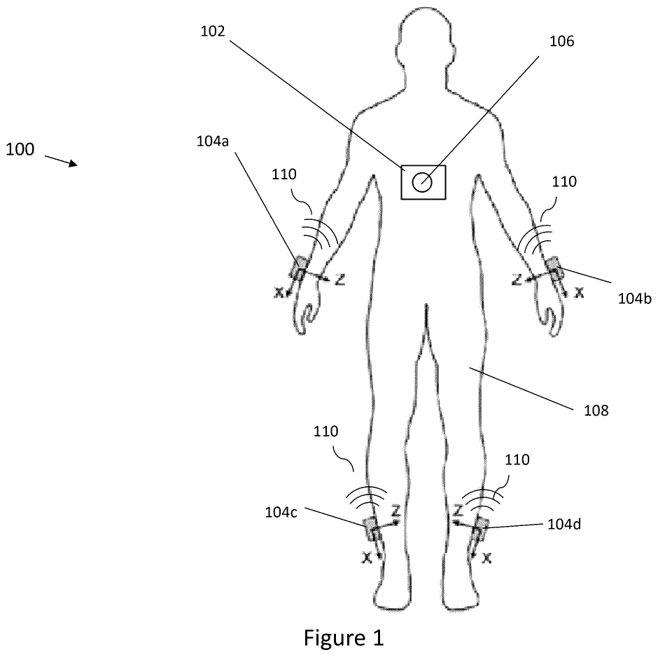

The operation of the optical sensor, the inertial measurement units and the hub is described in greater detail below in conjunction with FIGS. 1 to 5.

FIG. 1 shows a body 108 on which a tracking system 100 is deployed, the tracking system 100 comprising a plurality of inertial measurement units 104a, 104b, 104c and 104d and a hub 102 on which an optical sensor 106 is integrated. In one approach, the tracking system 100 may deploy 9 to 17 inertial measurement units, but for the sake of simplicity, only four are shown.

The tracking system 100 also further comprises one or more processors, which are not shown. The term “processor” may refer to one or more units for processing including an application specific integrated circuit (ASIC), central processing unit (CPU), graphics processing unit (GPU), programmable logic device (PLD), microcontroller, field programmable gate array (FPGA), microprocessor, digital signal processor (DSP), or other suitable component. The processor can be configured using machine readable instructions stored on a memory. The processor may be centralised or distributed, including distributed on various components that form part of or are in communication with the tracking system 100. The processor may be arranged in one or more of: a peripheral device, which may include a user interface device, an HMD; a personal computer or the like. Accordingly, the one or more processors may be distributed over any of the inertial measurement units 104a, 104b, 104c and 104d, the hub 102, the optical sensor 106 and a computing platform that receives the output data stream from the hub 102 that maps body motion into the computing environment. In the implementation where one of the processors is hosted in such a computing platform, the computing platform is one of the components of the tracking system 100. The deduction of the body part movement in the computing environment and the deduction of the position of the body in the computing environment may be performed in the computing platform to generate the data stream in the computing platform.

Each of the plurality of inertial measurement units (IMU) 104a, 104b, 104c and 104d is worn on a body part to measure data collected along each of roll, yaw, and pitch axes. Each of the inertial measurement units 104a, 104b, 104c and 104d measures linear acceleration along one or several directions using one or more accelerometers; angular motion about one or several axes using one or additional gyroscopes; and a magnetometer to provide a heading reference. As acceleration is proportional to external force, the accelerometer reading can reflect both the intensity and frequency of movement of the body part. By integrating accelerometer reading data with respect to time, velocity and displacement information of a body part can be derived. Each of the plurality of inertial measurement units 104a, 104b, 104c and 104d may also have a battery source, status LEDs and a vibration motor to provide haptic feedback.

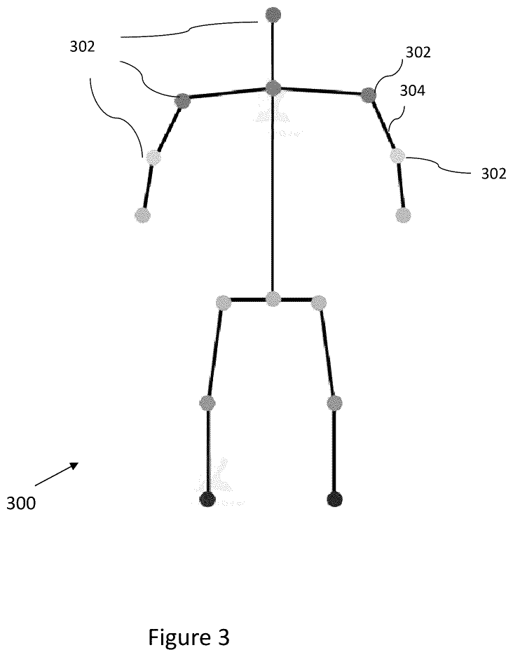

As mentioned above, while the plurality of inertial measurement units 104a, 104b, 104c and 104d can measure both linear acceleration and rotational acceleration data of the body parts on which they are worn, rotation data measured by each of the plurality of inertial measurement units 104a, 104b, 104c and 104d can simply be used to obtain estimates of the position and orientation of each body part during motion capture, with the use of forward kinematic algorithms. However, errors in the measured data leads to drift in these estimates, with this drift being correctible by fusing the IMU rates with other data measurements. In the present application, one possible implementation corrects the location of the plurality of inertial measurement units derived from their measured rotation data against visual data when they are seen by the optical sensor 106, where it is to be noted that this visual capture is not the determining factor for the location of the plurality of inertial measurement units. Other data measurements include correction based on including linear acceleration data measured by the plurality of inertial measurement units 104a, 104b, 104c and 104d. It will also be appreciated that calibration against body part dimensions, as described in greater detail below with respect to FIG. 3, improves accuracy of the body part simulation.

In addition to its central module role in consolidating output data by its optical sensor 106 and output data from the plurality of inertial measurement units 104a, 104b, 104c and 104d, the hub 102 also acts as an access point for the plurality of inertial measurement units 104a, 104b, 104c and 104d. This allows wireless communication between the plurality of inertial measurement units 104a, 104b, 104c and 104d and the hub 102; and allows scaling the number of inertial measurement units that can be used to track motion capture. The more inertial measurement units used the more granular the animation becomes. The type of sensors that can be used for the optical sensor 106 include a stereoscopic camera,

LIDAR and optical sonar sensors. In addition, the optical sensor 106 may be an arrangement that uses one or more of such sensors. The optical sensor 106 may transmit its captured frames over a hardwire connection with a hub 102 processor; or in an implementation where the optical sensor 106 communicates wirelessly with the hub 102 processor, via a wireless communication channel.

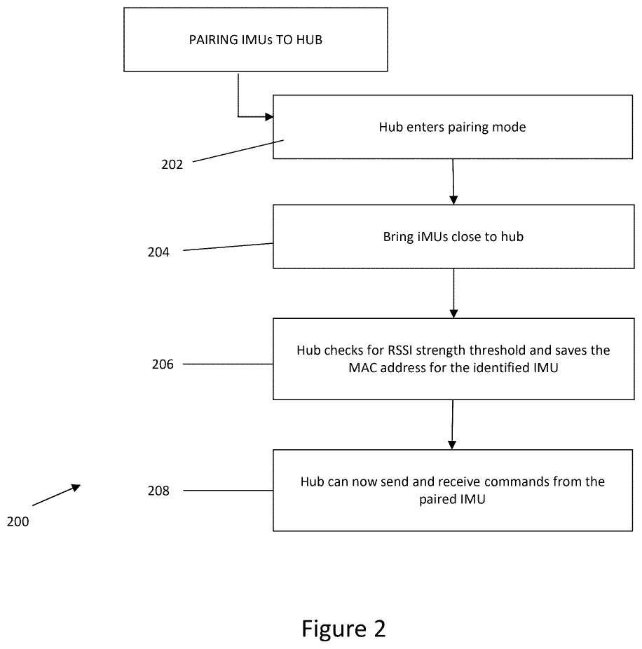

FIG. 2 shows a flow chart 200 for the pairing of the plurality of inertial measurement units 104a, 104b, 104c and 104d with the hub 102.

Before deployment, the tracking system 100 is operated in a pairing mode in step 202, to pair the plurality of inertial measurement units 104a, 104b, 104c and 104d with the hub 102 to allow them to act as a single entity.

The hub 102 may be implemented using microcontrollers that are based on an ESP32 chipset that supports wireless communication (e.g. over WiFi and Bluetooth®) and configurable to pair with the plurality of inertial measurement units 104a, 104b, 104c and 104d through proximity detection of their emitted wireless signal 110 in step 204. Wireless RSSI (Received Signal Strength Indicator) is accurate up to 1m, whereby the hub 102 will pair with the plurality of inertial measurement units 104a, 104b, 104c and 104d that are closest, since they have the strongest RSSI. Accordingly, if there is in the vicinity other hubs that are also being paired with their respective inertial measurement units, the hub 102 will disregard those inertial measurement units even if they are detected, since they will have weaker RSSI compared to the plurality of inertial measurement units 104a, 104b, 104c and 104d. In one approach, this pairing to have the hub 102 recognise the plurality of inertial measurement units 104a, 104b, 104c and 104d is done without them being worn on the body 108.

Following this pairing, the hub 102 can then be used to deduce a body part on which each of the plurality of inertial measurement units 104a, 104b, 104c and 104d is worn, facilitated by the actuation that these body parts (such as, but not limited to, the limbs) are made to perform. For instance, a user may be asked to adopt a given starting pose (e.g. arms folded), then asked to adopt a second pose (e.g. arms raised) while specifying how the limbs should be actuated when doing so. A range of rotation data for each limb over the course of shifting to the second pose is expected, whereby the hub 102 is then able to perform limb assignment from detecting which of the plurality of inertial measurement units measure corresponding rotational data.

In step 206, the assignment of a body part on which each of the plurality of inertial measurement units 104a, 104b, 104c and 104d is worn is through analysis of the rotation data output by each of the plurality of inertial measurement units 104a, 104b, 104c and 104d during this actuation and the strength of its emitted wireless signal relative to the hub 102. The assignment may be simultaneously, for example, by deducing a chain of measured rotational data obtained from the shifting of the end points of limbs, like wrist and feet shift. Wearing the hub 102 around the middle of the body 108 also increases the accuracy of this deductive body part assignment. The hub 102 then saves a unique identifier (such as a MAC address) of each of the plurality of inertial measurement units 104a, 104b, 104c and 104d against the assigned respective body part. Each MAC address facilitates data and command exchange over the wireless channel used by each of the plurality of inertial measurement unit to communicate with the hub 102. Tracking of each specific body part is then obtained from referencing the inertial measurement unit with the corresponding unique identifier, which allows the hub 102 to send and receive commands and data to the plurality of inertial measurement units 104a, 104b, 104c and 104d in step 208.

Such deductive body part assignment makes pairing seamless. It removes the need to tie any of the plurality of inertial measurement units 104a, 104b, 104c and 104d to a specific body part and allows replacement of any of the plurality of inertial measurement units. The hub 102 will recognise a change has occurred from the original assignment setup missing a MAC address of the removed inertial measurement unit and a MAC address of the new inertial measurement unit. The hub 102 then stores the MAC address of the replacement inertial measurement unit, with its assignment to the respective body part being automatic because the MAC addresses for the other inertial measurement units remain unchanged. It also does not require the user to specify which of the limbs each of the plurality of inertial measurement units 104a, 104b, 104c and 104d is worn. The hub 102 may also have a battery source, status LEDs and a vibration motor to provide haptic feedback.

With reference to FIG. 3, the body part to inertial measurement unit assignment is used to populate nodes 302 of an internal kinematic humanoid structure 300 used by the hub 102 to drive animation of an avatar representation of the body 108 in the computing environment. The internal kinematic humanoid structure 300 modelling of the body 108 is further improved upon by using data on real-world dimensions of the body parts on which the plurality of inertial measurement units 104a, 104b, 104c and 104d is worn. This calibration of the internal kinematic humanoid structure 300, which is performed before tracking of the body 108 motion commences dimensions, is described in greater detail below. Such calibration factors an impact of data on dimensions of body parts when combining the output data from the plurality of inertial measurement units 104a, 104b, 104c and 104d with measured movement data obtained from the output of the optical sensor 106 when tracking the body 108 motion.

An aggregate distance 304 between adjacent nodes 302 may be derived from dimensions of the body parts wearing the plurality of inertial measurement units (refer 104a, 104b, 104c and 104d of FIG. 1). The example shown in FIG. 3 is the aggregate length 304 of the upper left arm between the node 302 on the left shoulder and the node 302 on the left elbow. Images of the various body parts may be used to derive their dimensions, for example using one or more of a machine learning algorithm or through reference against skeletal structure models obtained from a library.

In one approach, the optical sensor 106 of the hub 102 may be used to take the images of the body parts, with the hub 102 running the machine learning algorithm or performing the reference against skeletal structure models. In this approach, the hub 102 is not worn on the body 108 but turned to face the body 108 to acquire the necessary images for skeletal tracking of the body parts, which can provide, for example, lengths of different limbs. In addition, the plurality of inertial measurement units 104a, 104b, 104c and 104d may also be worn during image acquisition by the optical sensor 106 to cross reference RSSI data measurements with visual measurement data for accuracy, which allows the length derivation algorithm to also acquire from the RSSI data measurements the placement of the plurality of inertial measurement units 104a, 104b, 104c and 104d on the body 108. That is, the derivation of the dimensions is done in conjunction with the plurality of inertial measurement units 104a, 104b, 104c and 104d being worn on the respective body parts to cross reference strength of their emitted wireless signals 110 against measurement data based on the corresponding body part images. In another approach, the hub 102 may derive the dimensions of the body parts from images taken by another camera or receive these dimensions from another source which uses different skeletal tracking algorithms.

With the hub 102 paired with the plurality of inertial measurement units 104a, 104b, 104c and 104d, their body part assignment saved, and the internal kinematic humanoid structure 300 calibrated, the tracking system 100 can be used to track body 108 motion.

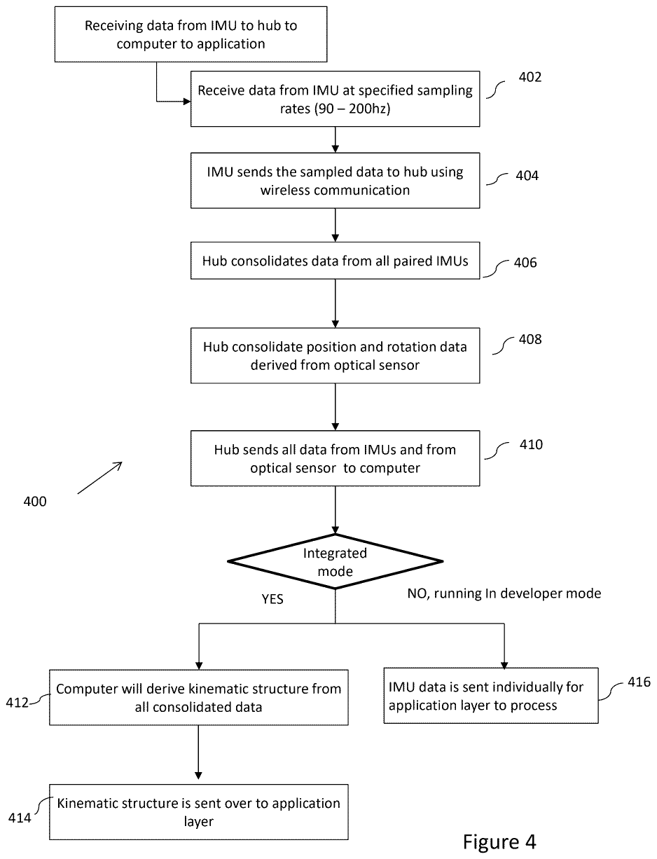

FIG. 4 shows a flow chart 400 of data acquisition by the tracking system 100 during body 108 motion capture and transmission to a receiving computer platform.

In step 402, a base pose for adoption is predetermined in the computing environment, which is typically a TPOSE. The body 108 is asked to copy this base pose before body 108 motion capture can commence. The base pose serves to zero the internal kinematic humanoid structure 300, which readies the internal kinematic humanoid structure 300 to be driven by the body 108 motion. A zero pose is when quaternion matrices at each of the nodes 302 of the internal kinematic humanoid structure 300 is at identity. A sampling rate for each of the plurality of inertial measurement units 104 a, 104 b, 104 c and 104 d is then specified, for example between 90 to 200 Hz. This sampled data is usable to derive an offset from the base pose, the offset being usable to construct a current pose. The sampled data includes rotational data and acceleration data measured by each of the plurality of inertial measurement units 104a, 104b, 104c and 104d.

In step 404, the plurality of inertial measurement units 104a, 104b, 104c and 104d sends the sampled data to the hub 102 using a wireless data communication protocol, such as WiFi or Bluetooth®. In steps 406 and 408, the hub 102 consolidates the rotational and acceleration data from the plurality of inertial measurement units 104a, 104b, 104c and 104d and the measured movement derived from the optical sensor 106. As the hub 102 is worn on the body 108, detection of successive frames captured by its optical sensor 106 being different indicates that the optical sensor 106 has moved from the body 108 shifting to a new location. Data measuring a degree of the movement bringing about this change is from referencing set points across the successive frames, in accordance with visual simultaneous localisation and mapping techniques. With reference to step 412, this movement data translates into a corresponding shift in the location of internal kinematic humanoid structure 300, while the measured rotational and acceleration data of the body parts translates into rotation and movement of corresponding segments of the internal kinematic humanoid structure 300. As mentioned above, the first frame that the optical sensor 106 captures provides the starting point to commence motion capture of the body 108 in the real-world environment. That is, a starting position is automatically acquired when the optical sensor 106 is initialised.

Returning to step 410, the hub 102 will transmit the rotational and acceleration data from the plurality of inertial measurement units 104a, 104b, 104c and 104d, along with the measured movement data from the optical sensor 106 to a computing platform which hosts the computing environment for the internal kinematic humanoid structure 300.

The consolidated data in the hub 102 will be combined before transmission as a data stream that drives the internal kinematic humanoid structure 300 to simulate the body 108 motion into the computing environment when the hub 102 is operated in an “integrated” mode. This is where the output of the plurality of inertial measurement units 104a, 104b, 104c and 104d; and the output from the optical sensor 106 is fused, so that the output data from one of the plurality of inertial measurement units can impact the output data from another of the plurality of inertial measurement units. Step 412 then occurs where the platform derives the internal kinematic humanoid structure 300 from the combined data of rotational and acceleration data; and measured movement data, both obtained while tracking the body 108 motion. In step 414, the internal kinematic humanoid structure 300 is then sent to an application layer for use in virtual reality applications.

Alternatively, when operated in a “developer” mode, the hub 102 is configured to allow extraction of the measured rotational and acceleration data from one or more of the plurality of inertial measurement units 104a, 104b, 104c and 104d and/or movement data from the optical sensor 106, obtained while tracking the body 108 motion, for recording as a macro. Step 416 then occurs where one or more of the plurality of inertial measurement units 104a, 104b, 104c and 104d outputs may be individually extracted and sent to an application layer for use in virtual reality applications. Recorded macros may, for example, describe controlling a volume knob or describe a vertical hand raise.

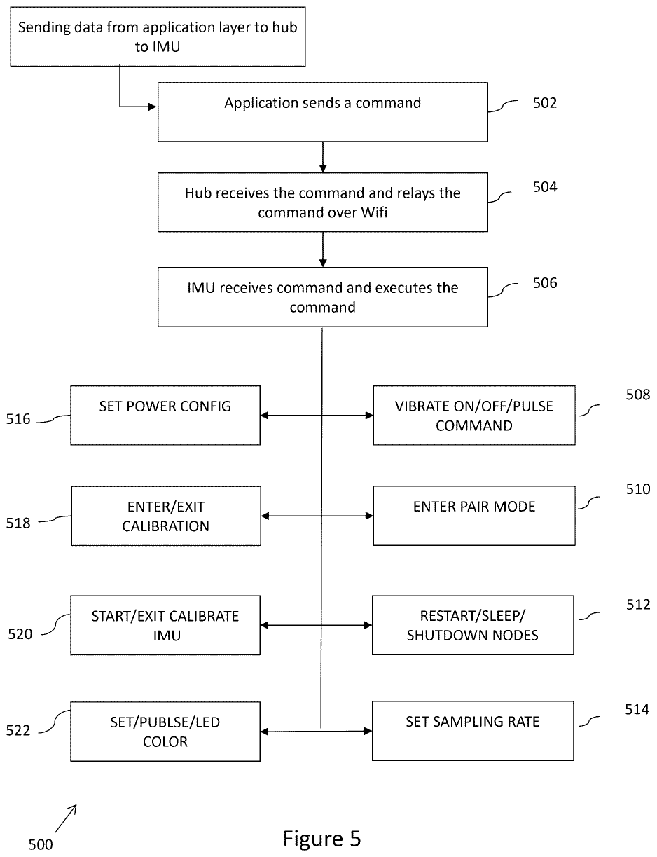

FIG. 5 shows a flow chart for sending data from an application layer to the tracking system 100.

In step 502, an application sends a command to the hub 102. Examples of commands include having the tracking system 100 enter a pairing mode (see FIG. 2) or to track body motion after the hub 102 has been calibrated.

In step 504, the hub 102 receives the command and relays the command to one or more of the plurality of inertial measurement units 104a, 104b, 104c and 104d using a wireless data communication protocol, such as WiFi or Bluetooth®. Each of the plurality of inertial measurement units 104a, 104b, 104c and 104d receives the command in step 506 and acts on them accordingly. Example commands are briefly described in steps 508, 510, 512, 514, 516, 518, 520 and 522.

Step 508 relates to commands that operate the vibration motors in the hub 102 and the plurality of inertial measurement units 104a, 104b, 104c and 104d. These commands allow for haptic feedback in response to scenarios occurring in the computing environment.

Step 510 occurs when the hub 102 is to be paired with the plurality of inertial measurement units 104a, 104b, 104c and 104d, as described with respect to FIG. 2.

Step 512 is to restart, shutdown or have the plurality of inertial measurement units 104a, 104b, 104c and 104d enter into a shutdown mode.

Step 514 allows for a user to define sampling rates, as described with respect to FIG. 4.

Step 516 allows for power configuration.

Steps 518 and 520 allows for calibration of the plurality of inertial measurement units 104a, 104b, 104c and 104d to body part dimensions, as described with respect to FIG. 3.

Step 522 allows for setting up of the status LEDS in the hub 102 and the plurality of inertial measurement units 104a, 104b, 104c and 104d.

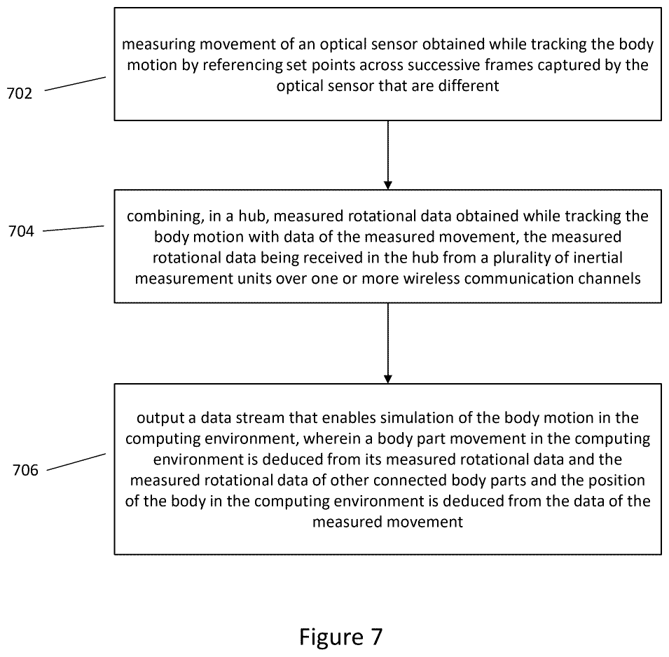

FIG. 7 shows a flow chart used by the tracking system 100 for simulating body motion into a computing environment.

In step 702, movement of an optical sensor obtained while tracking the body motion is measured by referencing set points across successive frames captured by the optical sensor that are different.

In step 704, a hub combines measured rotational data obtained while tracking the body motion with data of the measured movement from step 702, the measured rotational data being received in the hub from a plurality of inertial measurement units over one or more wireless communication channels.

In step 706, a data stream that enables simulation of the body motion in the computing environment is output, wherein a body part movement in the computing environment is deduced from its measured rotational data and the measured rotational data of other connected body parts. The position of the body in the computing environment is deduced from the data of the measured movement.

In the application, unless specified otherwise, the terms “comprising”, “comprise”, and grammatical variants thereof, intended to represent “open” or “inclusive” language such that they include recited elements but also permit inclusion of additional, non-explicitly recited elements.

While this invention has been described with reference to exemplary embodiments, it will be understood by those skilled in the art that various changes can be made and equivalents may be substituted for elements thereof, without departing from the spirit and scope of the invention. In addition, modification may be made to adapt the teachings of the invention to particular situations, without departing from the essential scope of the invention. Thus, the invention is not limited to the particular examples that are disclosed in this specification, but encompasses all embodiments falling within the scope of the appended claims.

1. A tracking system for simulating body motion into a computing environment, the system comprising
one or more processors;
an optical sensor configured to signal that movement of the optical sensor has occurred through the one or more processors detecting that captured successive frames are different, the one or more processors measuring the movement by referencing automatically determined and undefined set points across the successive frames;
a plurality of inertial measurement units, each controlled by the one or more processors to measure rotational data; and
a hub in communication with the inertial measurement units and the optical sensor, wherein the hub receives the rotational data from the plurality of inertial measurement units over one or more wireless communication channels, the hub controlled by the one or more processors to combine the rotational data obtained while tracking the body motion with data of the measured movement obtained while tracking the body motion, to output a data stream that enables simulation of the body motion in the computing environment, wherein a body part movement in the computing environment is deduced from measured rotational data of the body part and the measured rotational data of other connected body parts and a position of the body in the computing environment is deduced from the data of the measured movement.

2. The tracking system of claim 1, wherein a quaternion representation of the rotational data is used to deduce the body part movement in the computing environment.

3. The tracking system of claim 1, wherein the deduction of the body part movement in the computing environment is based on one or more forward kinematic algorithms.

4. The tracking system of claim 1, wherein the optical sensor is integrated with the hub and movement of the optical sensor occurs from motion of the body on which the hub is worn.

5. The tracking system of claim 1, wherein measurement of movement commences from the optical sensor capturing a first frame, the first frame providing a starting point for tracking the body motion.

6. The tracking system of claim 1, wherein the hub is configured to pair with the plurality of inertial measurement units through proximity detection of emitted wireless signal from the plurality of inertial measurement units.

7. The tracking system of claim 6, wherein the hub is further configured to determine assignment of a body part on which each of the plurality of inertial measurement units is worn through analysis of output rotational data and strength of emitted wireless signal relative to the hub.

8. The tracking system of claim 7, wherein the hub is further configured during pairing to save a unique identifier of each of the plurality of inertial measurement units against the assigned body part.

9. The tracking system of claim 6, wherein following pairing the one or more processors is configured to perform calibration using data on dimensions of body parts on which the plurality of inertial measurement units is worn before tracking of the body motion commences.

10. The tracking system of claim 9, wherein the one or more processors analyses images containing the body parts to derive dimensions of the body parts.

11. The tracking system of claim 10, wherein the dimensions are derived using one or more of a machine learning algorithm and skeletal structure models.

12. The tracking system of claim 10, wherein the images are taken by the optical sensor.

13. The tracking system of claim 10, wherein the derivation of the dimensions is done in conjunction with the plurality of the inertial measurement units being worn on the respective body parts to cross reference strength of their emitted wireless signals against measurement data based on the corresponding body part images.

14. The tracking system of claim 1, wherein a base pose for adoption before body motion capture can commence is predetermined in the computing environment.

15. The tracking system of claim 14, wherein the measured rotational data is used to derive an offset from the base pose, the offset being usable to construct a current pose.

16. The tracking system of claim 1, wherein the hub is configured to allow extraction of the measured rotational data from one or more of the plurality of inertial measurement units and/or the data of the measured movement from the optical sensor, obtained while tracking the body motion, for recording as a macro.

17. The tracking system of claim 1, wherein a position of the body obtained from the data of the measured movement is based on visual simultaneous localisation and mapping.

18. The tracking system of claim 1, wherein the optical sensor is any one or more of a stereoscopic camera, LIDAR and optical sonar sensors.

19. The tracking system of claim 1, wherein at least one of the one or more processors is hosted in a computer platform, wherein the deduction of the body part movement in the computing environment and the deduction of the position of the body in the computing environment is performed in the computer platform to generate the data stream in the computer platform.

20. (canceled)

21. A method of simulating body motion into a computing environment, the method comprising
measuring movement of an optical sensor obtained while tracking the body motion by referencing automatically determined and undefined set points across successive frames captured by the optical sensor that are different;
combining, in a hub, measured rotational data obtained while tracking the body motion with data of the measured movement, the measured rotational data being received in the hub from a plurality of inertial measurement units over one or more wireless communication channels; and
output a data stream that enables simulation of the body motion in the computing environment, wherein a body part movement in the computing environment is deduced from measured rotational data of the body part and the measured rotational data of other connected body parts and a position of the body in the computing environment is deduced from the data of the measured movement.
